(19) United States
(12) Patent Application Publication
(10) Pub. No.: US 2012/0266485 A1
(43) Pub. Date: Oct. 25, 2012

(54) DEVICE AND METHOD FOR CREATING A FINE-GRAINED FUEL FROM SOLID OR PASTE-LIKE RAW ENERGY MATERIALS BY MEANS OF TORREFACTION AND CRUSHING

(75) Inventors: Ralf Abraham, Bergkamen (DE); Stefan Hamel, Wenden (DE); Ralf Schaefer, Ruessingen/Pfalz (DE)

(73) Assignees: PROACTOR SCHUTZRECHTSVERWALTUNGSGMBH, Ruessingen (DE); THYSSENKRUPP UHDE GMBH, Dortmund (DE)

(21) Appl. No.: 13/508,913

(22) PCT Filed: Nov. 16, 2010
(86) PCT No.: PCT/EP10/06955

§ 371 Date: Jul. 13, 2012

(30) Foreign Application Priority Data
Nov. 16, 2009 (DE) 10 2009 053 059.2
Feb. 4, 2010 (DE) 10 2010 006 921.3

(51) Int. Cl. F26B 19/00; F26B 3/02

(52) U.S. Cl. 34/386; 34/61

(57) ABSTRACT

An apparatus and method for creating a fine-grained fuel from solid or paste-like raw energy materials by torrefaction. The apparatus including an impact reactor having a rotor and impact elements which is temperature resistant up to 350 degrees Celsius, a feed device for hot circulation gas in the lower region of the impact reactor, a feed device for solid or paste-like raw energy materials in the head region of the impact reactor. The apparatus further including at least one withdrawal device for a gas flow having comminuted and torrefacted raw energy particles and a separation and withdrawal device for crushed and torrefacted raw energy particles from the gas flow taken out of the impact reactor.

The invention relates to the thermal pre-treatment, i.e. torrefaction, of carbon and hydrogen-containing solid fuels in an impact reactor. In the following said fuels, which may also be of a pasty or viscous consistency, are referred to as solid or pasty energy feedstocks, and include, for example, biogenous and other highly-reactive fuels, fossil fuels and residues. Pasty refers to all materials which contain a mixture of solids and liquid components, examples being sewage sludges and industrial residues that are either aqueous-based or based on solvents or energy-containing liquids, such as oleaginous substances or lubricants. There has been a universal drive towards developing the use of regenerative energy sources and recycling waste and residues with thermal gasification permitting particularly effective utilisation from both an energetic and a material point of view. Entrained-flow gasification is particularly advantageous, with plants for entrained-flow gasification usually having extremely large capacities and also being run on coal. The invention also enables difficult waste to be used in entrained-bed combustion plants or boiler plants—difficult waste in this sense being, for instance, the fibrous and ligneous components that are mostly found in younger coals and can still be recognised as plant remains.

Before solid fuels can be used in an entrained-bed gasifier, they need to be crushed to a suitable particle size; reducing their moisture content is also advantageous. In the case of energy feedstocks such as biomasses, biogenous residues and waste, such pre-treatment based on conventional state of the art is energy and equipment-intensive due to the often tough, fibrous structure. For example, it is known that the thermal treatment of a biomass at mild pyrolysis conditions, i.e. torrefaction, weakens the cell structure to such an extent that the mechanical effort for subsequent crushing is greatly reduced.

Torrefaction refers to a mild thermal treatment of solid fuels at temperatures of 220 to 350° C. under the exclusion of oxygen—although in the present invention small quantities of oxygen are also permitted. The residence time required to achieve complete torrefaction of the feedstock is in the range of 15 to 120 minutes. The residence time is determined by the particle size of the feedstock and the heat transfer characteristic of the process used. While the feedstock is heating up, it first undergoes the drying step. As it heats up further, taking wood by way of example in this case, carbon dioxide and organic acids, such as acetic acid and formic acid, are first given off alongside the steam up until approximately 200-220° C. On further heating up until approximately 280-350° C., it is mainly carbon dioxide and organic acids that continue to be given off as well as increasing amounts of carbon monoxide due to the incipient pyrolytic decomposition as the temperature rises.

If the temperature continues to be increased beyond the temperature range relevant to the invention, the pyrolytic decomposition reactions of the marcomolecules increase rapidly beyond 350-400° C. (depending on the biomass). The quantity of the gases given off increases, although the maximum amount of higher hydrocarbons released, e.g. in the case of beechwood, is reached at about 480-500° C. At this temperature range, some 70 wt. % of the water and ash-free fuel substance from, for example, beechwood, is released as higher, condensable hydrocarbons, also generally referred to as tars. Some 15 wt. % is released as gas and around 15 wt. % is left as a solid residue, so-called coke.

In addition to carbon and hydrogen many biogenous feedstocks also contain considerable amounts of oxygen and other elements, all in bound form. During entrained-flow gasification, which takes place in a reducing, oxygen-deficient atmosphere for the production of synthesis gas, the oxygen compounds from the fuel are released, which leads to a greater amount of carbon dioxide being produced in the synthesis gas than desired, and furthermore to the production of steam instead of hydrogen. Therefore, it is desirable to reduce the molecular ratio of oxygen compounds in the biogenous feedstock used as early as the pre-treatment stage where possible, achieving through this depletion of oxygen a fuel upgrade that thus improves the quality of the synthesis gas to be produced.

Various processes for the torrefaction of biomasses are known in the art. A fundamental overview of the basic procedure for such processes is provided, for example, by Kaltschmitt et al., “Energie aus Biomasse”, ISBN 978-3-540-85094-6, 2009, pages 703-709. According to what is written here, various basic types of reactor can be used for biomass torrefaction, for example fixed-bed or moving-bed reactors, drum reactors, rotating-disc reactors and screw or paddle reactors. WO 2007/078199 A1, for example, proposes a moving-bed reactor and WO 2005/056723 A1, for instance, presents a configuration variant of a torrefaction process.

The common thing about all of these above processes is that they are aimed at the thermal treatment of biomasses. There is no provision for subsequent treatment, i.e. crushing, of the torrefied biomass and this must be done in a subsequent step. Hence, in the above examples from the existing state of the art, crushing or grinding inevitably requires a further process step and thus additional machinery.

Therefore, the objective of the invention is to provide a contrivance technically simplified in terms of equipment and an energy-saving process that allows torrefaction and crushing to be carried out in a single step, with the solid or pasty energy feedstocks being sufficiently pre-treated to allow them to undergo entrained-flow gasification without the need for further steps.

The invention achieves this objective via a contrivance, comprising
an impact reactor with a rotor and impact elements, said reactor being heat resistant up to 350 degrees Celsius,
a hot torrefaction gas feed device at the bottom of the impact reactor,
a solid or pasty energy feedstock feed device at the top of the impact reactor,
at least one device for discharging a gas stream containing crushed, torrefied energy feedstock particles, and
a device for separating and discharging crushed, torrefied energy feedstock particles from the gas stream discharged from the impact reactor.

In a preferred embodiment of the invention the torrefaction gas is introduced into the impact reactor near a labyrinth seal and/or through a labyrinth seal positioned near the rotor shaft of the impact reactor, said seal separating the inside of the impact reactor from the outside environment in terms of fluid communication. This advantageously results in a particularly efficient distribution of the torrefaction gas inside the impact reactor as well as a product stream that flows up from the bottom of the reactor, the torrefied particles being transported upwards in said stream.

A further embodiment of the invention envisages deflector wheel classifiers as the separation and discharge device for crushed, torrefied energy feedstock particles.

An advantageous embodiment of the invention also envisages a closed-loop configuration, the gas loop also comprising
a post-combustion device for the gas stream obtained from the separation device, said gas stream having been depleted of crushed, torrefied energy feedstock particles, and said post-combustion device having a device for utilising the waste heat from the flue gas obtained,
a device for feeding nitrogen into the closed-loop gas stream,
a pressurisation device in the closed-loop gas stream, and
a device for coupling the waste heat obtained from the flue gas into the closed-loop gas stream.

When fed in at the bottom of the impact reactor or at a point therein that is suitable from a process point of view, the closed-loop gas stream also forms the torrefaction gas stream that transports the required heat.

An advantageous embodiment of the invention also envisages providing a branch for a closed-loop gas stream and a residual gas stream downstream of the device for separating and discharging crushed, torrefied energy feedstock particles from the gas stream discharged from the impact reactor and positioning a booster burner in the closed-loop stream downstream of the branch for the closed-loop stream. This booster burner may be positioned either in the side stream or in the main stream of the recycle gas.

OS DE 196 00 482 A1 describes, for example, a suitable impact reactor. Surprisingly, this vessel is able to treat biomass, such as straw or green waste, in the same way it does the plastic fractions described. In order to improve effectiveness, it may also be expedient to use devices, such as those described in patent application DE 10 2005 055 620 A1.

A further objective of the inventive contrivance relates to the discharge of torrefied material, with the impact reactor permitting to withdraw various fractions of different grain sizes. The invention achieves the objective by providing lateral screens for separating and discharging crushed, dried energy feedstock particles. In this way different designs and mesh sizes allow the separation of different grain fractions.

Other embodiments of the inventive contrivance relate to the supply of the torrefaction gas at the bottom of the impact reactor. Here, it is the objective of the invention to also allow the introduction of larger amounts of torrefaction gas into the impact reactor.

The invention achieves the objective by providing bores as feed devices for hot torrefaction gas distributed over the circumference at the bottom of the impact reactor. Another embodiment of the invention envisages that the bores are arranged with radial inclination. Another advantageous embodiment of the invention can envisage that the bores are aligned tangentially to the direction of rotation of the impact elements. In so doing, the outlet direction of the bores can be aligned in or opposite to the direction of rotation of the impact reactor rotor. The more favourable solution from the process point of view depends on the interaction of the properties of the material to be crushed and the geometric design of the rotor and the impact elements and the mode of operation of the rotor, i.e. for example, the speed and resulting impact on the local flow operations.

Alternatively, the invention achieves the objective by providing slot-shaped openings as feed devices for hot torrefaction gas distributed over the circumference at the bottom of the impact reactor. Here, the slots, too, can have a radial inclination.

In another embodiment of the invention the slots are formed by mounting the base plates in an overlapping way.

All types of torrefaction gas supply can also be used in combination. Hence, it is possible to introduce torrefaction gas to the impact reactor via the described labyrinth seal and via the feed devices for energy feedstocks as well as via bores and slots at the bottom of the impact reactor and to thus respond to very different feedstocks from the process point of view, this being an advantage of the invention.

The objective of the invention is also achieved by means of a process for the production of a fine-grained fuel from solid or pasty energy feedstocks through torrefaction and crushing using an impact reactor with a rotor and impact elements,
said solid or pasty energy feedstocks being fed into an impact reactor at the top of said impact reactor at 190 to 350 degrees Celsius,
hot torrefaction gas being added at the bottom of the impact reactor,
the solid or pasty energy feedstocks being crushed, dried and torrefied in the impact reactor, and
crushed, torrefied energy feedstock particles contained in a gas stream from the impact reactor being directed to a particle separator.

The present invention envisages thermal treatment in the typical torrefaction temperature range, i.e. from 190-350° C. This firstly results in an around 30% decrease in mass with a reduction of around only 10% in the energy content, a considerably higher specific calorific value thus being achieved. Secondly, the torrefaction changes the structure of the biomass from fibrous to brittle, thus greatly reducing the energy required for crushing. Depending on the degree of torrefaction and the type of biomass the amount of energy required for crushing can be reduced by between 50% and 85%; see Kaltschmitt et al.: “Energie aus Biomasse”, ISBN 978-3-540-85094-6, 2009, pages 703-709.

The fact that torrefaction and crushing take place at the same time in the present invention creates synergy effects from which both processes benefit. In the state of the art torrefaction takes place in a separate reactor, i.e. depending on the size of the particles and the reactor-dependent heat transfer properties, the particles need a certain residence time in order for them to be completely and thoroughly torrefied. At a constant reactor temperature, this reactor residence time can only be achieved by reducing the particle size, which needs to be done before the particles are fed into the reactor. The torrefied particles are then crushed to a target size.

Due to the simultaneous treatment in the invention, rapid drying occurs when the coarse particles have been fed in and due to further heating of the particles a corresponding torrefaction from the outside to the inside also occurs from the outside of the particle to the inside. Whereas in familiar state-of-the-art processes the size of the particle remains the same during torrefaction, in this case crushing takes place at the same time due to the impact effect, the outer particle layers that have already been torrefied preferably being knocked off on contact with the impact elements due to their brittle material properties. The remaining particle core that has not yet been fully torrefied is thus re-exposed and with a concomitant reduced size again subjected to the full heat transfer. Due to the continuous crushing and mechanical removal of the torrefied layers, the overall torrefaction time of a single particle is considerably reduced. At the same time, the mechanical effort required for the crushing is reduced as the parts of the particle that have already been torrefied and are thus brittle can be crushed far more effectively.

On the one hand, the invention considerably reduces the demand for technical equipment of the conventional treatment chain and at the same time also reduces the specific lead time required.

Some embodiments of the invention also envisage closed-loop operation with
at least part of the gas stream obtained from the particle separator being subjected to a post-combustion device, the energy from the flue gas obtained being used directly or indirectly to heat the closed-loop gas stream,
nitrogen being fed to the closed-loop gas stream,
the pressure loss in the closed-loop gas stream being compensated, and
the heated closed-loop gas stream being recycled back to the bottom part of the impact reactor.

Other embodiments of the process envisage that the dust-laden gas discharged from the particle separator is branched off into a closed-loop gas stream and a residual gas stream and the closed-loop stream is also heated in the side stream or in the main stream or in both.

Another further improved embodiment of the process envisages that at least part of the torrefaction gas is fed to the reactor together with the energy feedstocks by means of the related feed device. In doing so, it must be ensured that the torrefaction gas is sufficiently cool when being introduced into the feed device. The introduction of the torrefaction gas causes the outer surface of energy feedstocks, particularly solid energy feedstocks, to begin to dry, resulting in improved conveying properties and a considerably reduced tendency of adhesion. The torrefaction gas can be passed through in both counter-current and concurrent flow.

Another embodiment of the process envisages that the feed device is heated indirectly. On account of the drying effect the torrefaction gas cools down when entering the feed device. Heating actively counteracts this cooling. For heating it is also possible to use the hot torrefaction gas which thereby cools down and is then passed through the feed device.

If it is envisaged to first discharge the energy feedstocks from the bin by means of a screw conveyor and then to feed them at metered quantities into the impact reactor by means of a star-wheel feeder, this sequence would have to be turned round in the present case. This prevents that torrefaction gas passed through the feed device can flow back into the bin. The torrefaction gas can be introduced into the impact reactor in an unimpeded way by means of a screw conveyor which is open towards the impact reactor. In this, it is advantageous to route the energy feedstocks and the torrefaction gas in concurrent flow through the screw conveyor.

The invention also relates to the use of the solid energy feedstocks treated in this manner in an entrained-bed gasification unit, in an entrained-bed combustion plant, in a fluidised-bed gasification unit and in a fluidised-bed combustion plant.

The invention is explained in greater detail below by means of five process drawings with a closed-loop mode of operation, taking the torrefaction of biomass as an example.

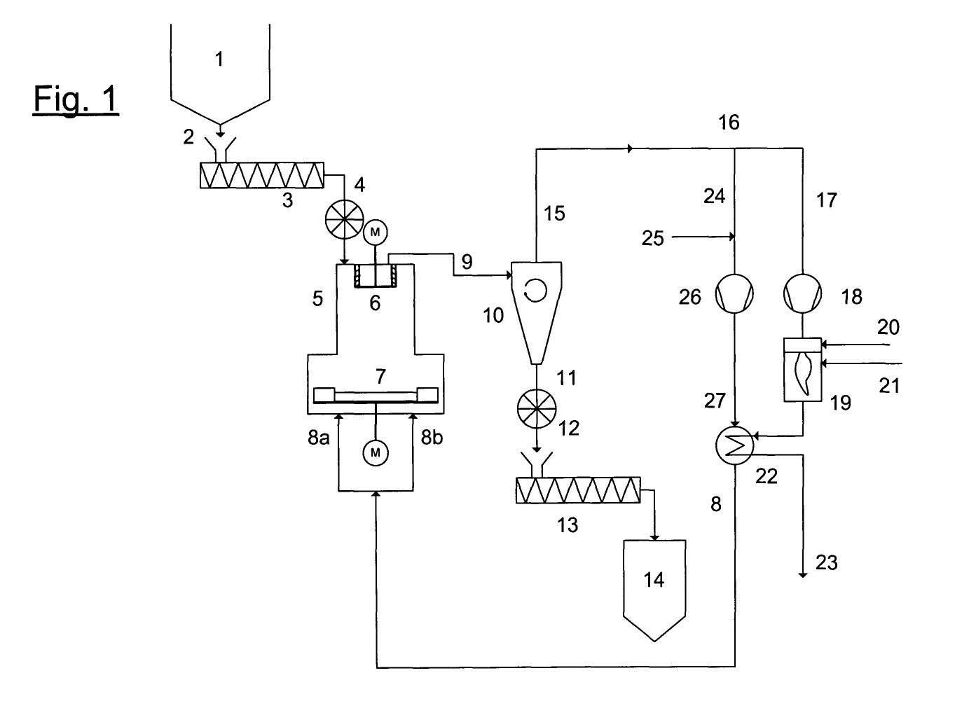

FIG. 1 shows the process in accordance with the invention with indirect additional heating of the recycle gas.

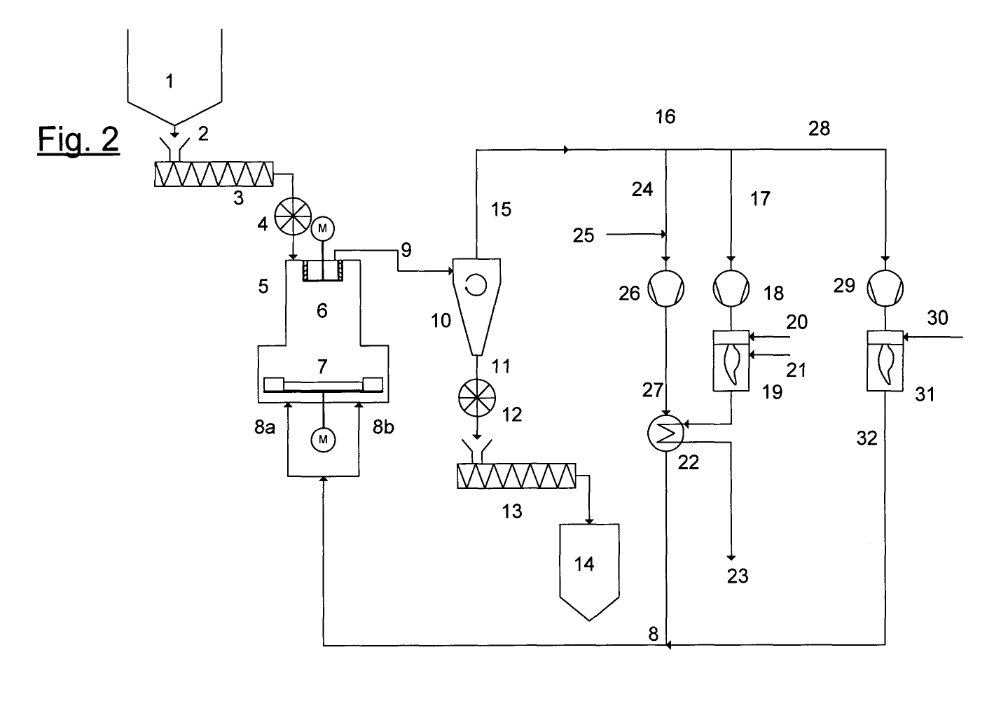

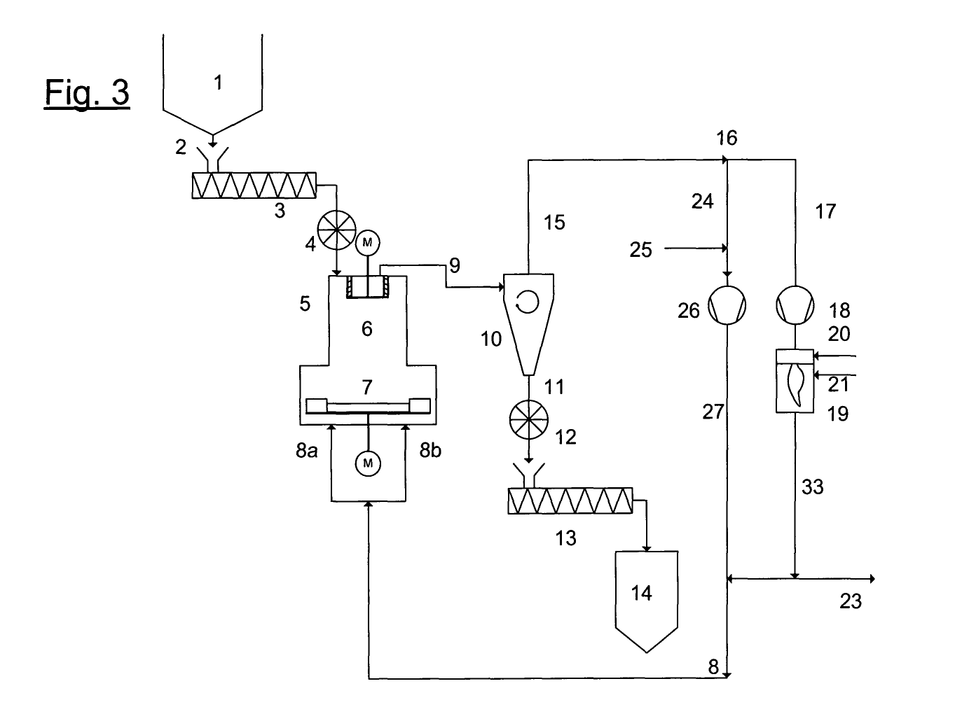

FIGS. 2 and 3 envisage branching and

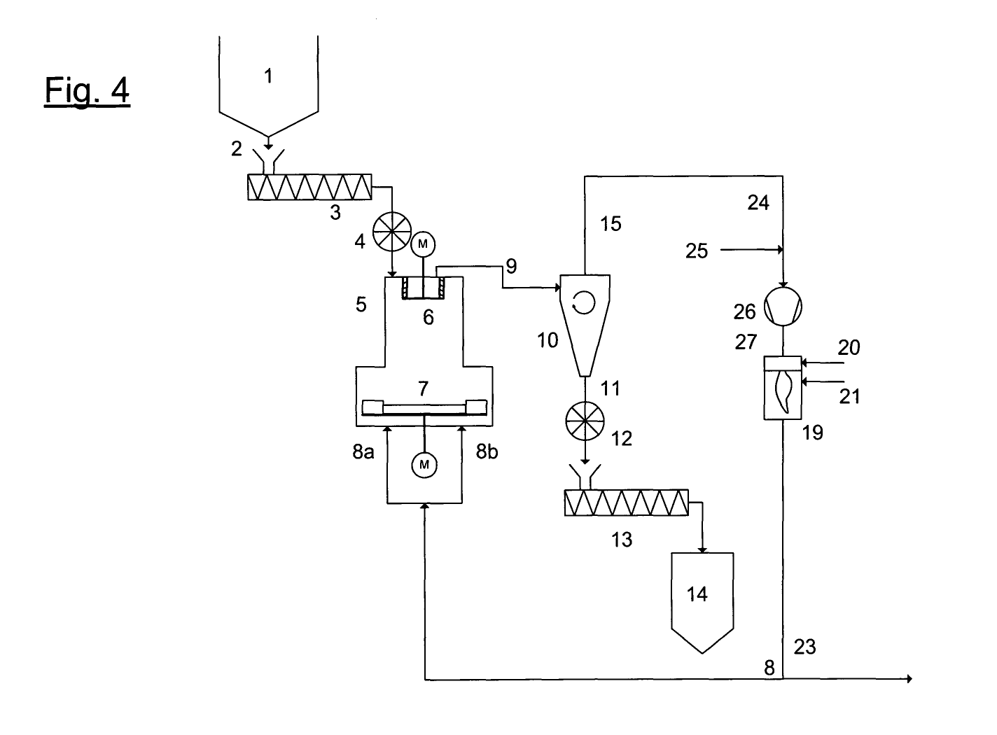

FIG. 4 shows a process with direct additional heating and no branching.

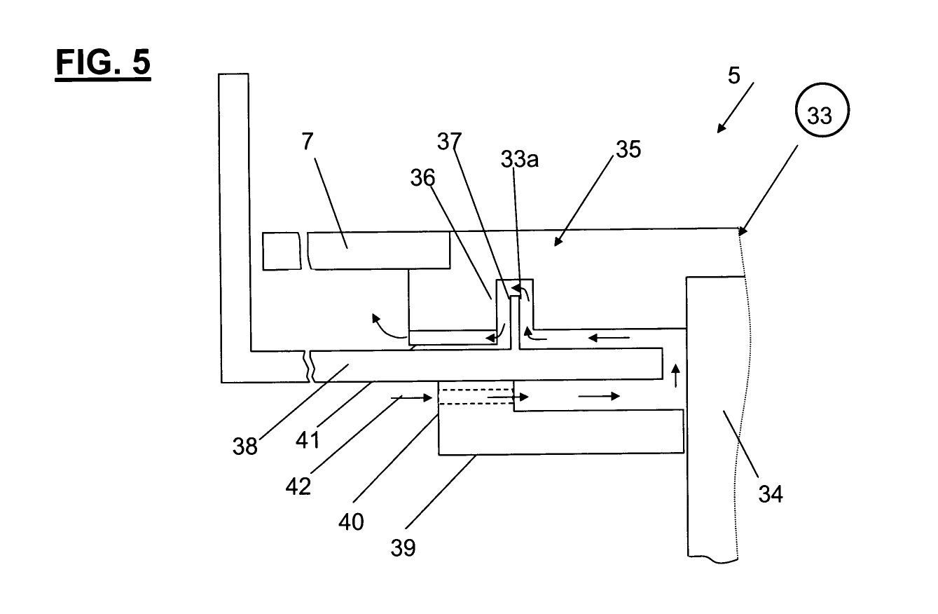

FIG. 5 illustrates the labyrinth seal in accordance with the invention.

The biomass 2 is conveyed from the feed tank 1 into the impact reactor 5 via the screw conveyor 3 and the star-wheel feeder 4. Here, it is crushed by means of the rotor 7. Torrefaction gas is added at the bottom of the impact reactor 5 in the form of hot recycle gas 8a and 8b. The crushed, dried, torrefied particles 11 are discharged from the impact reactor 5 with the gas stream 9 via a classifier 6—preferably a motor-driven rotary classifier—and directed to the particle separator 10, shown here as a centrifugal separator.

An advantage here is that the use of the classifier 6 allows the size of the particles being discharged with the gas stream 9 to be adjusted. It may also be advantageous to dispense with the motor-driven rotary classifier and use screens or perforated plates which allow the size of the solids particles contained in the gas stream 9 to be controlled.

Depending on the desired use of the pre-treated fuel, the target particle size of the torrefied particles 11 is defined by different requirements of the gasification or combustion plant. These are, for instance, requirements regarding the interaction of reactivity and particle size, the flow characteristics, and so forth, so different particle sizes or particle size distributions may be advantageous for different feedstocks. Therefore, different methods of pre-separation, such as classifiers or screens, are also feasible. Depending on the desired particle size, it may also be feasible to use either an inertial separator or a filtering separator as the particle separator 10.

In the particle separator 10 the torrefied particles 11 are separated out and discharged by means of the star-wheel feeder 12. They are then fed to the feed tank 14 by the screw conveyor 13.

The recycle gas 15 that is obtained from the centrifugal separator 10 contains only small amounts of dust as well as the gas components that are released during torrefaction of the feedstock and need to be post-combusted. After the branch 16, a residual gas stream 17 is directed by means of the fan 18 into the burner 19 where the residual gas is post-combusted together with the air 20 and the fuel gas 21. In the heat exchanger 22 the hot flue gas transfers its energy to the recycle gas 27 and can then be discharged to the atmosphere 23.

Nitrogen 25 is added to the recycle gas 24 in about the same amount as the residual gas 17 is discharged, with a maximum oxygen content of 8% being set at the impact reactor inlet. The pressure loss is compensated in the recycle gas compressor 26, and the recycle gas 27 is heated in the heat exchanger and recycled to the impact reactor as hot recycle gas 8. At the same time, the feed devices are positioned, by way of example, so that the hot recycle gas 8 is added near the labyrinth seal 33 and at the same time the labyrinth seal itself 33 is permeated.

In FIG. 2 a side stream 28 is branched off from the recycle gas 16. By a support fan 29 this side stream 28 is conveyed to the air 30 -operated auxiliary burner 31 where it is heated. The hot gas 32 is remixed with the recycle gas 8.

In contrast to FIG. 1, FIG. 3 cuts out the heat exchanger 22 by feeding the flue gas 33 directly back into the recycle gas 27 after a part of it has been discharged to the atmosphere 23.

In FIG. 4 the burner 19 is positioned directly in the recycle gas 27. This process variant is preferable, for example, when the gas components released from the torrefaction account for a considerable quantity and calorific value.

In accordance with the invention the process for the thermal pre-treatment of carbon and hydrogen-containing solid fuels can also be carried out without a closed loop. This is particularly advantageous when integration into an existing plant infrastructure is planned. For example, if the aim is to co-gasify biomass and coal in an entrained-bed gasifier, coupling is possible by feeding in the gas stream 15 emitted from the gasification unit, in this case, for instance, the heat-up burner at the coal mill. At the same time, the pre-heated gas stream 8a, 8b that is to be fed in can also be provided from the gasification unit. This may be, for example, a part stream from the heated recycle gas from the coal mill or, for example, consist of an inert gas stream pre-heated within the gasification unit.

For co-gasification, the torrefied particles 11 obtained can be fed via the feed tank 14 either into the coal dust stream or fed to the coal mill together with the raw coal largely depending on the degree of crushing that has been selected in the impact reactor 5.

The described coupling with the gasification unit merely serves as an example and there are many alternatives as there are a great many part and auxiliary streams as well as a great many possibilities for heat extraction within a complex gasification unit with an upstream coal mill.

In the same way coupling can also be carried out with a power plant process that has a combustion unit, the torrefied particles 11 obtained being directed in such cases to the co-gasification unit via the feed tank 14.

Furthermore, FIG. 5 shows a detailed view of the part of the impact reactor 5 near the rotor shaft 34, via which the rotor 7 is driven by a motor that is not shown. As can be seen from FIG. 5, at the top end of the rotor shaft 34 there is a rotor connection 35, with an annular channel or groove 36 inserted into the bottom which has, for example, a rectangular cross-section. An annular projection 37, which is preferably positioned on the base plate 38 of the impact reactor 5, extends into the annular channel 36 from the bottom up. The projection 37 has a width that is smaller than the width of the channel 36 and its top does not extend fully to the bottom of the channel, thus creating a labyrinth seal 33 with a labyrinth passage 33a between the outer surface of the projection 37 and the inner surface of the channel 36, through which the torrefaction gas or other gas is introduced into the inside of the impact reactor 5. The labyrinth passage may, for example, have a width in the range of 2 mm to 20 mm.

In accordance with an embodiment of the invention not shown, in order to improve the seal effect, the labyrinth seal 33 may also have, in a radial direction, two or more projections 37 which extend into appurtenant channels 36 shaped to match the shape of the projections.

The torrefaction gas 8a, 8b is preferably fed along the feed route indicated by the arrows 42 through one or more holes 40 arranged in the shaft arrangement 39 underneath the base plate 38. This route first runs in the direction of the rotor shaft 34, i.e. the centre of rotation of the rotor 7, then essentially in an upwards direction parallel to the rotor shaft or rotation axis of the rotor 7 and subsequently above the base plate 38 back in the opposite direction radially outwards away from the centre of rotation of the impact reactor 5 through the labyrinth passage 33a, which results in particularly efficient sealing and distribution of the torrefaction gas inside the reactor. This can also be further improved by using one or more impact slats 41 downstream of the labyrinth passage 33a in terms of flow.

### LIST OF REFERENCE NUMBERS AND DESIGNATIONS

1 Feed tank
2 Biomass
3 Screw conveyor
4 Star-wheel feeder
5 Impact reactor
6 Classifier
7 Rotor
8, 8a, 8b Hot recycle gas/torrefaction gas
9 Gas stream
10 Particle separator
11 Torrefied particles
12 Star-wheel feeder
13 Screw conveyor
14 Feed tank
15 Recycle gas
16 Recycle gas
17 Residual gas
18 Fan
19 Burner
20 Air
21 Fuel gas
22 Heat exchanger
23 Atmosphere
24 Recycle gas
25 Nitrogen
26 Recycle gas compressor
27 Recycle gas
28 Side stream
29 Support fan
30 Air
31 Auxiliary burner
32 Hot gas
33 Labyrinth seal
33a Labyrinth passage
34 Rotor shaft
35 Rotor connection
36 Channel
37 Projection
38 Base plate
39 Shaft arrangement
40 Hole
41 Impact slat
42 Arrows
M Motor

1. An apparatus for the production of a fine-grained fuel from solid or pasty energy feed-stocks by means of torrefaction and crushing, comprising:
an impact reactor with a rotor and impact elements, said reactor being temperature-resistant up to 350 degrees Celsius;
at least one hot torrefaction gas feed device at the bottom of the impact reactor;
at least one solid or pasty energy feedstock feed device at the top of the impact reactor;
at least one device for discharging a gas stream containing crushed, torrefied energy feedstock particles; and
a device for separating and discharging crushed, torrefied energy feedstock particles from the gas stream discharged from the impact reactor.

2. The apparatus according to claim 1, wherein the torrefaction gas is introduced into the impact reactor near a labyrinth seal and/or through a labyrinth seal positioned near the rotor shaft of the impact reactor.

3. The apparatus according to claim 1, wherein the deflector wheel classifiers are envisaged as the separation and discharge device for crushed, torrefied energy feedstock particles.

4. The apparatus according to claim 1, wherein a closed-loop configuration with a the gas loop, also comprising
at least one post-combustion device for the gas stream obtained from the separation device, said gas stream having been depleted of crushed, torrefied energy feedstock particles,
at least one device for feeding nitrogen into the closed-loop gas stream,
at least one pressurisation device in the closed-loop gas stream,
at least one device for coupling the waste heat obtained from the flue gas into the closed-loop gas stream.

5. The apparatus according to claim 1, wherein a branch is provided for a closed-loop gas stream and a residual gas stream downstream of the device for separating and discharging crushed, torrefied biomass particles from the gas stream discharged from the impact reactor and in that a booster burner is positioned in the closed-loop stream downstream of the branch for the closed-loop stream.

6. The apparatus according to claim 5, wherein a booster burner is positioned in the main stream of the closed-loop stream.

7. The apparatus according to claim 6, wherein a booster burner is positioned in the side stream of the closed-loop stream.

8. The apparatus according to claim 1, wherein lateral screens are provided for separating and discharging crushed, dried energy feedstock particles.

9. The apparatus according to claim 1, wherein bores are provided as feed devices for hot torrefaction gas distributed over the circumference at the bottom of the impact reactor.

10. The apparatus according to claim 9, wherein the bores are arranged with radial inclination.

11. The apparatus according to claim 10, wherein in that the bores are aligned tan-gentially to the direction of rotation of the impact elements.

12. The apparatus according to claim 1, wherein slot-shaped openings are provided as feed devices for hot torrefaction gas distributed over the circumference at the bottom of the impact reactor.

13. The apparatus according to claim 12, wherein the slots have a radial inclination.

14. The apparatus according to claim 12, the slots are formed by mounting the base plates in an overlapping way.

15. A method for the production of a fine-grained fuel from solid or pasty energy feedstocks through torrefaction using an impact reactor with a rotor and impact elements:
said solid or pasty energy feedstocks being fed into the impact reactor at the top of said impact reactor;
hot torrefaction gas being added at the bottom of the impact reactor;
the energy feedstocks being crushed, dried and torrefied in the impact reactor; and
crushed, torrefied energy feedstock particles contained in a gas stream from the impact reactor being directed to a particle separator.

16. The method according to claim 15, wherein closed-loop operation is envisaged, with;
at least part of the gas stream obtained from the particle separator being subjected to a post-combustion device, the energy from the flue gas obtained being used directly or indirectly to heat the closed-loop gas stream;
nitrogen being fed to the closed-loop gas stream;
the pressure loss in the closed-loop gas stream being compensated; and
the heated closed-loop gas stream being recycled back to the bottom part of the impact reactor.

17. The method according to claim 15, wherein in that the closed-loop stream is also heated in the side stream or in the main stream.

18. The method according to claim 15, wherein the dust-laden gas discharged from the particle separator is branched off into a closed-loop gas stream and a residual gas stream.

19. The method according to claim 15, wherein at least part of the torrefaction gas is fed to the reactor together with the energy feedstocks by means of the related feed device.

20. The method according to claim 15, wherein the device for feeding the energy feedstock to the reactor is heated indirectly.

21.-24. (canceled)
